(19) United States
(12) Patent Application Publication
(10) Pub. No.: US 2009/0152953 A1
(43) Pub. Date: Jun. 18, 2009

(54) Hybrid Power Supply Apparatus with Fuel Cell Output Control

(75) Inventors: Ming-Yao Dong, ChuPei City (TW); Wen-Hsing Chang, ChuPei City (TW)

Correspondence Address: NIKOLAI & MERSEREAU, P.A., 900 SECOND AVENUE SOUTH, SUITE 820, MINNEAPOLIS, MN, 55402, US

(73) Assignee: SYSPOTEK CORPORATION, ChuPei City (TW)

(21) Appl. No.: 12/328,455

(22) Filed: Dec. 4, 2008

(30) Foreign Application Priority Data
Dec. 17, 2007 (CN) 200710302209.3

(51) Int. Cl. H02J 7/34

(52) U.S. Cl. 307/80

(57) ABSTRACT

A hybrid power supply apparatus with fuel cell output control comprises: a first power supply circuit and a second power supply circuit, the first power supply circuit consisting of a first power unit, a first voltage conversion unit, a sensor unit, and a control unit, wherein the voltage conversion unit is connected to the power unit, and contains a DC voltage booster circuit or a DC voltage buck circuit to convert the DC power generated by the power unit into DC power of specific voltage for output; the sensor unit being able to detect the voltage or the current of DC power output by the first power unit that enables the control unit to control the DC power conversion ratio of the first voltage conversion unit or stop the DC power conversion by the first voltage conversion unit based on the electric signal fed from the sensor unit, thereby protecting the first power unit.

The second power supply circuit comprises a second power unit and a second voltage conversion unit, and works with the first power supply circuit to supply hybrid power to meet the power demand of the load.

### FIELD OF THE INVENTION

The present invention relates to a hybrid power supply apparatus with fuel cell output control, more particularly, a power supply apparatus that utilizes the coordination between different power supply devices to meet the power demand of the load.

### BACKGROUND OF THE INVENTION

Because of the work characteristics of conventional fuel cell, when a fuel cell outputs power to a load, the power voltage/current characteristics would vary with the load demand. When the fuel cell is insufficient to meet the power demand of the load, the fuel cell will not be able to generate sufficient electrical potential, which might indirectly harm the operation of the fuel cell. Thus there have been hybrid power supply apparatus that contain a secondary battery or other DC power supplier to ensure sufficient power supply to the load.

However the aforementioned approach still cannot ensure precisely the stability of voltage/current output. Hence in light of the drawbacks of conventional hybrid power apparatus with fuel cell output control, the present invention aims to develop a hybrid power supply apparatus that is able to dynamically and precisely control the inputted and outputted voltage/current and stabilize the voltage output.

### SUMMARY OF THE INVENTION

The hybrid power supply apparatus with fuel cell output control of the present invention comprises a first power supply circuit and a second power supply circuit. The first power supply circuit and the second power supply circuit are able to output power respectively to form a hybrid power system that outputs power corresponding to the load demand at the output terminal.

To achieve the aforesaid object, the present invention provides a hybrid power supply apparatus with fuel cell output control, which comprises a first power unit, a first voltage conversion unit, a sensor unit and a control unit. The first power unit is a power generating device that uses hydrogen-rich fuel and oxygen to undergo electrochemical reaction and generates power for output. The first voltage conversion unit is a DC/DC voltage conversion device and contains a DC voltage booster circuit or a DC voltage buck circuit to convert the DC power generated by the first power unit and inputted into the input terminal of the first voltage conversion unit into DC power of specific voltage for output. The sensor unit is a power detecting device for detecting the characteristics of power transmitted by the first power supply circuit and outputting an electrical signal corresponding to said power characteristics. The first power supply circuit and the second power supply circuit output power in parallel electrical connection. The control unit regulates the differential between the voltage output from the first voltage conversion unit and the voltage output from the second voltage conversion unit based on the signal fed from the sensor unit such that the first power supply circuit and the second power supply circuit would output power synchronously to the load. Hence the hybrid power supply apparatus with fuel cell output control could enable the first power unit to maintain stable power output, and at the same time, satisfy the power demand of the load in low-load state and high-load state by controlling the voltage output of the first voltage conversion unit and the second voltage conversion unit and coordinating the power output of the second power supply circuit.

In the aforesaid hybrid power supply apparatus with fuel cell output control, the second power supply circuit comprises a second power unit and a second voltage conversion unit. The second power unit is a power generating device, such as mechanical power generator, primary battery or secondary battery, and able to output power to the second voltage conversion unit. The second voltage conversion unit is a voltage conversion device that contains a DC voltage booster circuit or a DC voltage buck circuit to convert the power generated by the second power unit and inputted into the input terminal of the second voltage conversion unit into DC power of specific voltage for output.

The DC power outputted by the first power unit is transmitted to the first voltage conversion unit via the first power supply circuit to undergo DC/DC voltage conversion and outputted as DC power of specific voltage, which is then transmitted to the load to meet the DC power demand of the load. The sensor unit could detect the current, voltage or electric power state of the first power supply circuit and feed a corresponding electrical signal based on the detected result to the control unit. The control unit would then output a voltage signal corresponding to the signal fed from the sensor unit to the first voltage conversion unit so as to control the operation of the first voltage conversion unit. The sensor unit could detect the DC voltage or current outputted by the first power unit such that the control unit could control the DC/DC voltage conversion ratio of the first voltage conversion unit based on the electrical signal fed from the sensor unit so as to control the DC voltage or current level outputted by the first power unit so as to protect the first power unit.

The control unit could be replaced by a microcontroller, which carries out control through logic computing.

The objects, features and effects of the invention are described in detail below with embodiments in reference to the accompanying drawings.

### BRIEF DESCRIPTION OF THE DRAWINGS

FIG. 1 is the component diagram of a hybrid power supply apparatus with fuel cell output control according to a first embodiment of the invention;

FIG. 2 is the component diagram of a hybrid power supply apparatus with fuel cell output control according to a second embodiment of the invention;

FIG. 3 is the component diagram of a hybrid power supply apparatus with fuel cell output control according to a third embodiment of the invention;

FIG. 4 is a diagram showing the signal control of the hybrid power supply apparatus with fuel cell output control according to the invention;

FIG. 5 is another diagram showing the signal control of the hybrid power supply apparatus with fuel cell output control according to the invention;

FIG. 6 is the component diagram of a hybrid power supply apparatus with fuel cell output control according to a fourth embodiment of the invention;

FIG. 7 is the component diagram of a hybrid power supply apparatus with fuel cell output control according to a fifth embodiment of the invention;

FIG. 8 is the component diagram of a hybrid power supply apparatus with fuel cell output control according to a sixth embodiment of the invention;

FIG. 9 is a partial component diagram of the six embodiment of the invention; and

FIG. 10 is the component diagram of a hybrid power supply apparatus with fuel cell output control according to a seventh embodiment of the invention.

### DETAILED DESCRIPTION OF THE INVENTION

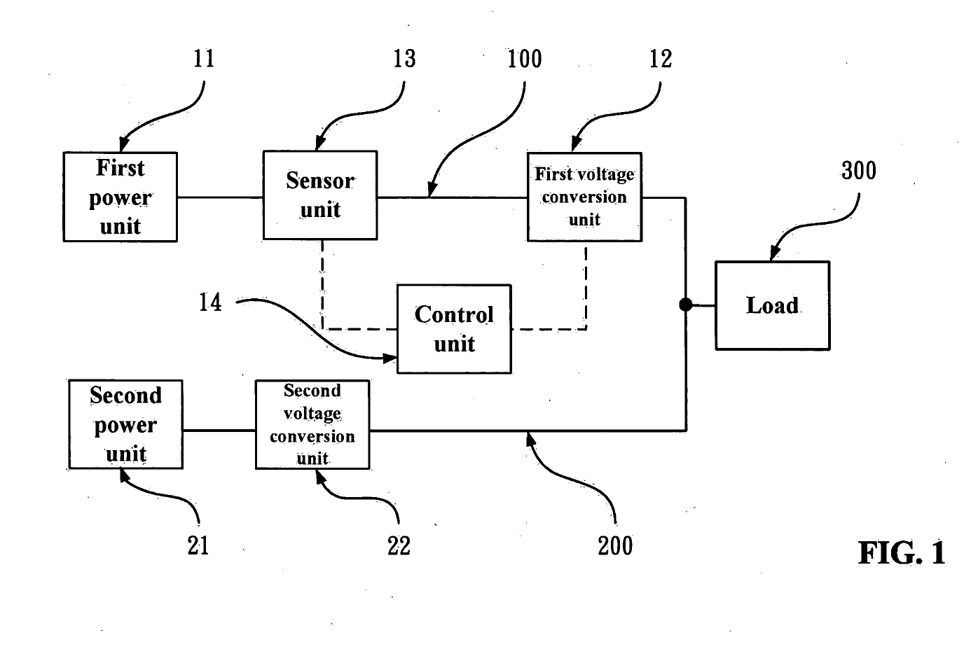

FIG. 1 is the component diagram of a hybrid power supply apparatus with fuel cell output control according to a first embodiment of the invention. The hybrid power supply apparatus with fuel cell output control comprises a first power supply circuit (100) and a second power supply circuit (200), the first power supply circuit (100) and/the second power supply circuit (200) are able to output power respectively to form a hybrid power system that outputs power corresponding to the load (300) demand at the output terminal.

In the hybrid power supply apparatus with fuel cell output control, the first power supply circuit (100) consists of a first power unit (11), a first voltage conversion unit (12), a sensor unit (13) and a control unit (14). The first power unit (11) is a power generating device that uses hydrogen-rich fuel and oxygen to undergo electrochemical reaction and generates power for output. The first voltage conversion unit (12) is a DC/DC voltage conversion device with one end electrically connected to the first power unit (11) and could contain a DC voltage booster circuit or a DC voltage buck circuit to convert the DC power generated by the first power unit (11) and inputted into the input terminal of the first voltage conversion unit (12) into DC power of specific voltage for output. The sensor unit (13) is a power detecting device for detecting the characteristics of power transmitted by the first power supply circuit (100) and outputting an electrical signal corresponding to said power characteristics. For example, the power characteristics could be the current level, voltage level or electric power level at a local loop of the first power supply circuit (100). The control unit (14) outputs a voltage signal corresponding to the inputted electrical signal and is electrically connected to the sensor unit (13) and the first voltage conversion unit (12). The control unit (14) produces a voltage signal corresponding to the power characteristic signal provided by the sensor unit (13), and feeds the voltage signal to the first voltage conversion unit (12) so as to determine the voltage level outputted after voltage conversion by the first voltage conversion unit (12).

In the aforesaid hybrid power supply apparatus with fuel cell output control, the second power supply circuit (200) comprises a second power unit (21) and a second voltage conversion unit (22). The second power unit (21) is a power generating device, such as mechanical power generator, primary battery or secondary battery, and able to output power to the second voltage conversion unit (22). The second voltage conversion unit (22) is a voltage conversion device that is electrically connected to the second power unit (21) at one end and contains a DC voltage booster circuit or a DC voltage buck circuit to convert the power generated by the second power unit (21) and inputted into the input terminal of the second voltage conversion unit (22) into DC power of specific voltage for output.

As such, the DC power outputted by the first power unit (11) could be transmitted to the first voltage conversion unit (12) via the first power supply circuit (100) to undergo the voltage conversion of DC power and output DC power of specific voltage, which is then transmitted to the load (300) to supply DC power needed by the load (300). Moreover, the sensor unit (13) could detect the current, voltage or electric power state of the first power supply circuit (100) and feed a signal corresponding to the detected result to the control unit (14). The control unit (14) outputs a voltage signal corresponding to the signal fed from the sensor unit (13) to the first voltage conversion unit (12) so as to control the operation of the first voltage conversion unit (12). When the sensor unit (13) is implemented by detecting the current level of the first power supply circuit (100) and the current level detected falls within a first preset range, the control unit (14) would output a corresponding voltage signal to control the conversion of inputted DG power by the first voltage conversion unit (12) into stable voltage power for output; and when the current level detected falls within a second preset range, the control unit (14) would output another corresponding voltage signal to control the conversion of inputted DC power by the first voltage conversion unit (12) into power of specific voltage for output and enable the power characteristic detected by the sensor unit (13) to return to the first preset range. Generally, the second preset range defined is higher than the first preset range defined such that current outputted by the first power unit (11) could be confined, thereby controlling the power output of the first power unit (11) and protecting the first power unit (11).

The sensor unit (13) detects the voltage or the current of DC power outputted by the first power unit (11) such that the DC/DC power conversion ratio of the first voltage conversion unit (12) could be controlled based on the electrical signal fed from the sensor unit (13) to achieve the effect of first power supply circuit (100) supplying power during low-load state and first power supply circuit (100) and the second power supply circuit (200) supplying hybrid power during high-load state, thereby protecting the first power unit (11).

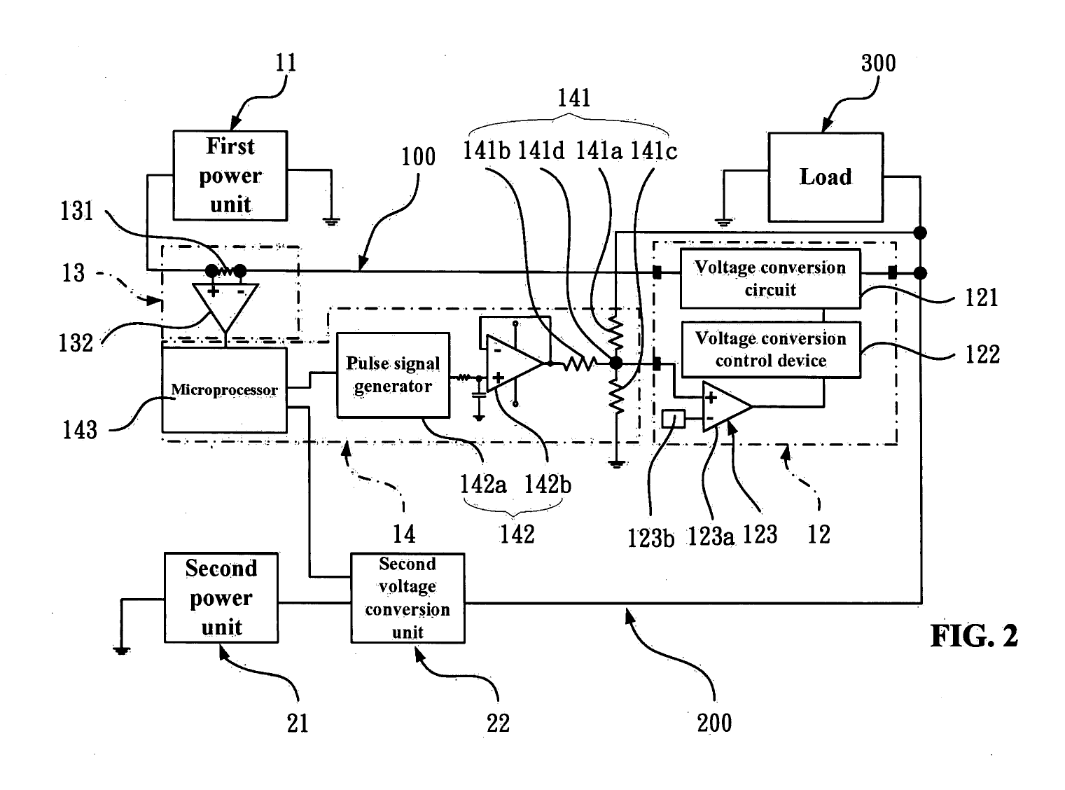

FIG. 2 is the component diagram of a hybrid power supply apparatus with fuel cell output control according to a second embodiment of the invention. Based on the aforesaid embodiment, the first voltage conversion unit (12) further contains a voltage conversion circuit (121), the voltage conversion circuit (121) being a circuit with a mechanism to store and release energy from the inputted DC power and electrically connected in series in the first power supply circuit (100). The voltage signal provided by the control unit (14) controls the operation of the voltage conversion circuit (121).

The first voltage conversion unit (12) further contains a voltage conversion circuit (121), a voltage conversion control device (122) and a judging device (123). The voltage conversion circuit (121) is a circuit with a mechanism for storing and releasing energy from the DC power and able to convert the power at the input terminal into power of specific voltage for output. The voltage conversion control device (122) is an electrical circuit controlling the voltage conversion circuit (121) to select energy storage or energy release. The judging device (123) is electrically connected to the voltage signal output terminal of the control unit (14) at one end, and based on the voltage signal outputted by the control unit (14), feeds a corresponding electrical signal to the voltage conversion control device (122). In the example of the voltage conversion circuit (121) being a booster circuit, the electrical signal outputted by the sensor unit (13) is converted into a voltage signal by the control unit (14) and fed to the judging device (123) of the first voltage conversion unit (12). Next, the judging device (123) would feed an electrical signal corresponding to the voltage signal outputted by the control unit (14) to the voltage conversion control device (122). Finally, the voltage conversion control device (122) would decide to open or close the DC power energy storage and release mechanism of the first voltage conversion unit (12) based on the electrical signal outputted by the judging device (123). As such, when the current level detected by the sensor unit (13) is lower than or equal to a preset range, the voltage conversion circuit (121) would convert the DC power inputted into constant voltage for output when the current level detected by the sensor unit (13) is higher than the preset range, the voltage conversion circuit (121) would lower the voltage level of power for Output and the current level detected by the sensor unit (13) would return to the preset, range. Under such control, the voltage conversion circuit (121) undergoes step-up conversion to maintain constant voltage output or lowers the output voltage after step-up conversion so as to further confine the current level of the first power supply circuit (100).

The judging device (123) is a voltage differential amplifier (123a) with one input terminal being electrically connected to the output terminal of the control unit (14), another input terminal being electrically connected to a reference voltage (123b), and an output terminal being electrically connected to the voltage conversion control device (122). The judging device (123) outputs the conversion result to the voltage conversion control device (122). The voltage conversion control device (122) then outputs a duty cycle signal based on the conversion result outputted by the judging, device (123) to control the selection of energy storage or energy release by the voltage conversion circuit (121), thereby achieving voltage conversion.

The sensor unit (13) further includes a resistor element (131) and a voltage differential amplifier (132). The resistor element (131) is electrically connected in series to the resistance in the first power supply circuit (100). The voltage differential amplifier (132) is a voltage differential amplification circuits made of an operational amplifier, the two input terminals of the voltage differential amplifier (132) being electrically connected in parallel to the two ends of the resistor element (131) to compare the voltage difference between the two ends of the resistor element (131), the voltage differential amplifier (132) outputting an electrical signal corresponding to the voltage difference between two the two ends of the resistor element (131) from its output terminal.

In the aforesaid embodiment, the sensor unit (13) outputs a digital or analog electrical signal based on the detected power characteristic (e.g. the current level) of the first power supply circuit (100). The control unit (14) would then output a corresponding control signal based on the electrical signal outputted by the sensor unit (13) and the voltage signal outputted by the voltage conversion circuit (121) of the first voltage conversion unit (12) so as to control the voltage conversion circuit (121) in the first voltage conversion unit (12), which in turn outputs a specific voltage signal. The control unit (14) can be any device that is able to convert the inputted electrical signal into a corresponding voltage signal, including digital-to-analog converter.

In the hybrid, power supply apparatus with fuel cell output control, the control unit (14) further consists of a voltage divider (141), a voltage generator device (142), and a microprocessor (143). The voltage divider (141) further contains a first resistor element (141a), a second resistor element (141b), a third resistor element (141c), and a voltage signal output terminal (141d), the other end of the first resistor element (141a) being electrically connected to the output terminal of the voltage conversion circuit (121) in the first power supply circuit (100), the other end of the second resistor element (141b) being electrically connected to the output terminal of the voltage generator device (142), and the other end of the third resistor (141c) being electrically connected to a voltage level. The voltage generator device (142) outputs a voltage signal to the second resistor element (141b) in the voltage divider (141) corresponding to the electrical signal outputted by the sensor unit (13). The microprocessor (143) has logic operation and logic control means, and carries out logic operation based on the electrical signal outputted by the voltage differential amplifier (132) and outputs a corresponding electrical signal to control the output of a corresponding voltage signal by the control unit (14), thereby monitoring the current level of the first power supply circuit (100) under the control of the microprocessor (143) and the corresponding operation of the first voltage conversion unit (12). As such, the voltage level at the voltage signal output terminal (141d) is consistent with the reference voltage, while voltage outputted by the voltage conversion circuit (121) and the voltage at the output terminal of the control unit (14) would be dependent of each other because of the voltage divider (141) formed by the first resistor element (141a), the second resistor element (141b), and the third resistor element (141c).

More specifically, in the hybrid power supply apparatus with fuel cell output control, the voltage generator device (142) in the control unit (14) further contains a pulse signal generator (142a) and a pulse-to-voltage converter circuit (142b). The pulse signal generator (142a) is an electrical device that generates pulse signal and outputs pulse signal of specific duty cycle based on the control signal provided by the microprocessor (143). The pulse-to-voltage converter circuit (142b) outputs a voltage signal corresponding to the magnitude of pulse signal and the pulse signal duty cycle provided by the pulse signal generator (142a), and transmits said voltage signal to the electrical junction of the voltage divider (141) and control unit (14).

The pulse-to-voltage converter circuit (142b) can be a voltage follower to lower the effect of the output terminal.

The pulse signal generator (142a) in the control unit (14) can regulate the magnitude of voltage outputted by the pulse-to-voltage converter circuit (142b) to the voltage divider (141) through pulse width modulation.

In the hybrid power supply apparatus with fuel cell output control, the two input terminals of the voltage differential amplifier (132) straddle across the two ends of the resistor element (131), and the resistor element (131) is electrically connected in series to the first power supply circuit (100). Moreover, the resistor element (131) of the sensor unit (13) is electrically connected in series to the first power supply circuit (100) and disposed opposing to the first power unit (11) or the high side or low side of the load (300).

In the hybrid power supply apparatus with fuel cell output control, the current sensor circuit composed of the resistor element (131) and the voltage differential amplifier (132) of the sensor unit (13) can be any other device capable of detecting the output current of the first power supply circuit (100) without being partially electrically connected in series to the first power supply circuit (100). For example, the sensor unit (13) includes, a Hall element to detect the current output of the first power supply circuit (100).

In the hybrid power supply apparatus with fuel cell output control, the voltage conversion circuit (121) in the first voltage conversion unit (12) is a DC voltage booster circuit, a DC voltage buck circuit or a synthetic circuit made of DC voltage booster and DC voltage buck circuits.

In the aforesaid hybrid power supply apparatus with fuel cell output control, the microprocessor (143) could simultaneously control the voltage conversion operation of the second voltage conversion unit (22) in the second power supply circuit (200) such that the hybrid power supply apparatus with fuel cell output control could determine the voltage output of respective power supply circuits and control the output power of the first power unit (11) by controlling the corresponding voltage conversion unit, and hence could select the switching between power supply circuits or allocate the power output of each power supply circuit.

In the aforesaid hybrid power supply apparatus with fuel cell output control, the microprocessor (143) compares a signal received from the sensor unit (13) with the preset voltage, current or power value and outputs a corresponding control signal to the pulse signal generator (142a) of the control unit (14) such that the pulse signal generator (142a) would output an electrical signal of specific duty cycle to the pulse-to-voltage converter circuit (142b), which is then transmitted to the voltage divider (141). Next, according to the Kirchhoff's current law, the voltage value at the voltage signal output terminal (141d) of the voltage divider (141) would change along with the voltage at the power output terminal of the voltage conversion circuit (121), while the voltage conversion control device (122) would choose to open or close the DC power energy storage and release mechanism of the voltage conversion circuit (121) based on the voltage value inputted into the voltage signal output terminal (141d) such that the voltage conversion circuit (121) would undergo corresponding voltage conversion. The judging device (123) would determine the voltage level at the voltage signal output terminal (141d) and outputs a corresponding electrical signal to the voltage conversion control device (122). The voltage conversion control device (122) would, based on the electrical signal fed by the judging device, choose to open or close the DC power energy storage and release mechanism of the first voltage conversion unit (12) so as to convert the DC voltage of the first voltage conversion unit (12) and limit the current level of the first power supply circuit (100). Under the aforesaid current-limiting mechanism, when the electric power outputted by the first power supply circuit (100) is insufficient for the power demand of the load (300), the second power supply circuit (200) would automatically output the power generated by the second power unit (21) to make up the power supply.

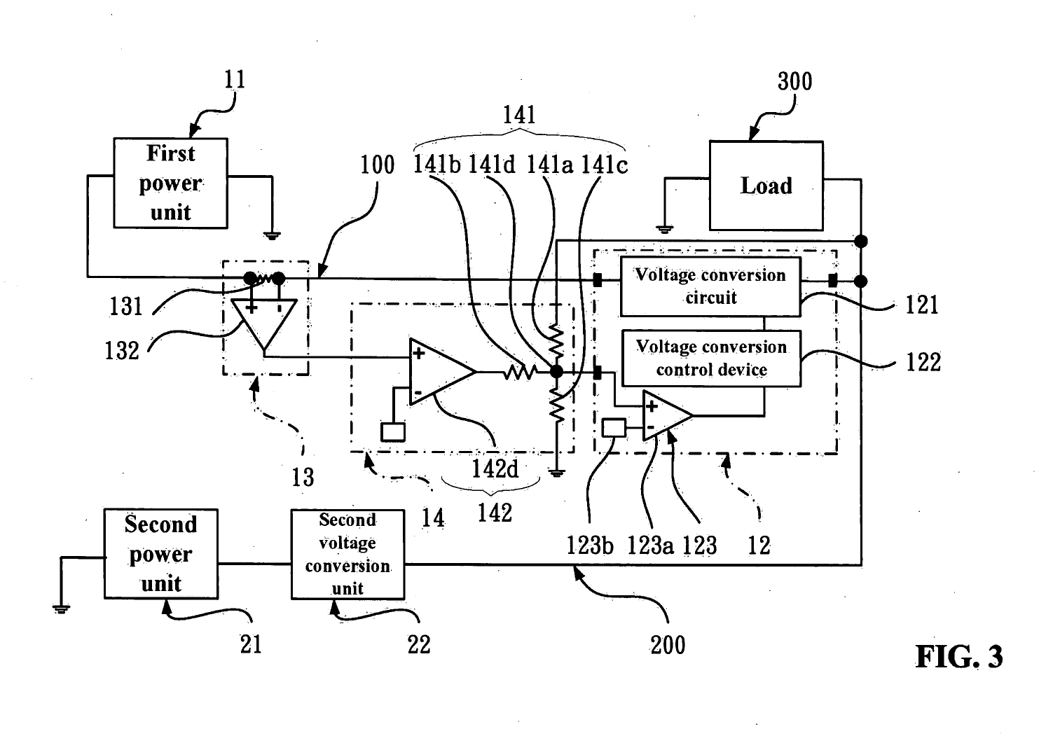

FIG. 3 is the component diagram of a hybrid power supply apparatus with fuel cell output control according to a third embodiment of the invention. Based on the aforesaid embodiment, the voltage generator device (142) of the control unit (14) further contains a second voltage differential amplifier (142d), the second voltage differential amplifier (142d) has a reference voltage, an input terminal electrically connected to the output terminal of the sensor unit (13), and an output terminal electrically connected to the second resistor element (141b) of the voltage divider (141) such that the second voltage differential amplifier (142d) could compare the voltage inputted by the sensor unit (13) with the reference voltage, and the second voltage differential amplifier (142d) would output a corresponding voltage signal to the second resistor element (141b). As such, the voltage signal level at the voltage signal output terminal (141d) of the voltage divider (141) would be modulated, and the voltage signal output terminal (141d) of the voltage divider (141) would reflect the voltage at the output terminal of the voltage conversion circuit (121).

In the aforesaid embodiment, the voltage conversion control device (122), the judging device (123), the voltage divider (141), the control unit (14) and the sensor unit (13) can be electrically connected to form ah integrated circuit (IC).

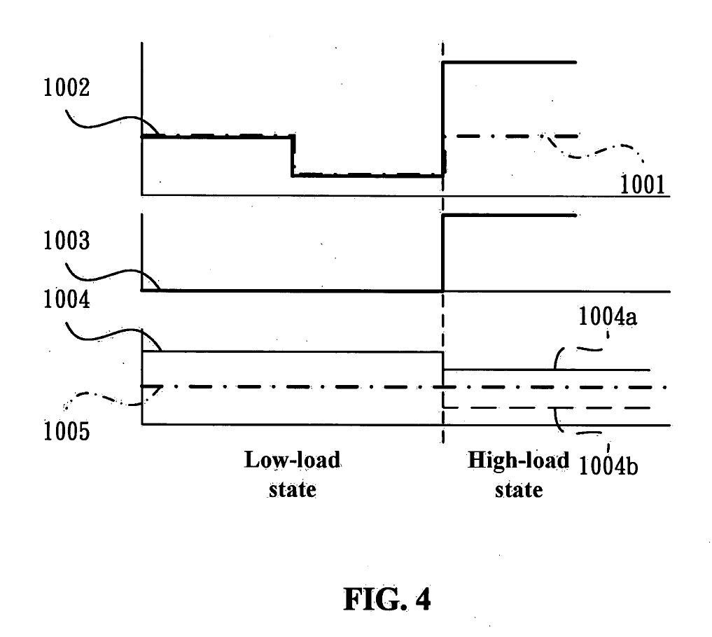

Referring to FIG. 1 and FIG. 4, which is a diagram showing the signal control of the hybrid power supply apparatus with fuel cell output control according to the invention, in the aforesaid hybrid power supply apparatus with fuel cell output control, the power generated by the first power unit (11) in the first power supply circuit (100) and converted by the first voltage conversion unit (12) for output is defined as a first power supply circuit output power (1001) and the output voltage thereof is defined as a first power supply circuit preset output voltage (1004). The power consumed by the load (300) is a load power loss (1002). The power generated by the second power unit (21) in the second power supply circuit (200) and converted by the second voltage conversion unit (22) for output is defined as a second power supply circuit output power (1003) and the output voltage thereof is defined as a second power supply circuit preset output voltage (1005). In the signal control diagram of FIG. 4, when the first power supply circuit output power (1001) is equal to or greater than the load power loss (1002), it is defined as a low-load state; when the first power supply circuit output power (1001) is smaller than the load power loss (1002), it is defined as a high-load state. In the low-load state, the first power supply circuit preset output voltage (1004) is slightly higher than the second power supply circuit preset output voltage (1005) so that the second power supply circuit output power (1003) outputted by the second power supply circuit (200) is zero, while the first power supply circuit output power (1001) could satisfy the load power loss (1002) of the load (300). In the high-load state, the control unit (14) would regulate the voltage conversion ratio of the first voltage conversion unit (12) according to the signal fed by the sensor unit (13) so that there is differential between the first power supply circuit preset output voltage (1004) and the second power supply circuit preset output voltage (1005). Under the circumstances, the first power supply circuit (100) and the second power supply circuit (200) would output power synchronously to the load (300), and the sum of first power supply circuit output power (1001) and the second power supply circuit output power (1003) would be equal to the load power loss (1002) of the load (300). As such, the hybrid power supply apparatus with fuel cell output control could limit the maximum power supply of the first power unit (11), and maintain stable power output and at the same time satisfy the power demand of the load (300) in low-load state and high-load state by controlling the voltage output of the first voltage conversion unit (12) and coordinating the power output of the second power supply circuit (200).

More specifically, if the output distribution ratio under steady-state output in high-load state is such that the first power supply circuit output power (1001) is higher than the second power supply circuit output power (1003), the first power supply circuit preset output voltage (1004) adopts a first preset voltage level (1004a) in the high-load state, and the first preset voltage level (1004a) is slightly higher than the second power supply circuit preset output voltage (1005). In addition, if the output distribution ratio under steady-state output in high-load state is such that the first power supply circuit output power (1001) is lower than the second power supply circuit output power (1003), the first power supply circuit preset output voltage (1004) adopts a second preset voltage level (1004b) in the high-load state, and the second preset voltage level (1004b) is slightly lower than the second power supply circuit preset output voltage (1005). In the aforesaid high-load state, the differential between the first preset voltage level (1004a) of the first power supply circuit preset output voltage (1004) and the second power supply circuit preset output voltage (1005), or the differential between the second preset voltage level (1004b) of the first power supply circuit preset output voltage (1004) and the second power supply circuit preset output voltage (1005) would determine the ratio of the first power supply circuit output power (1001) and the second power supply circuit output power (1003).

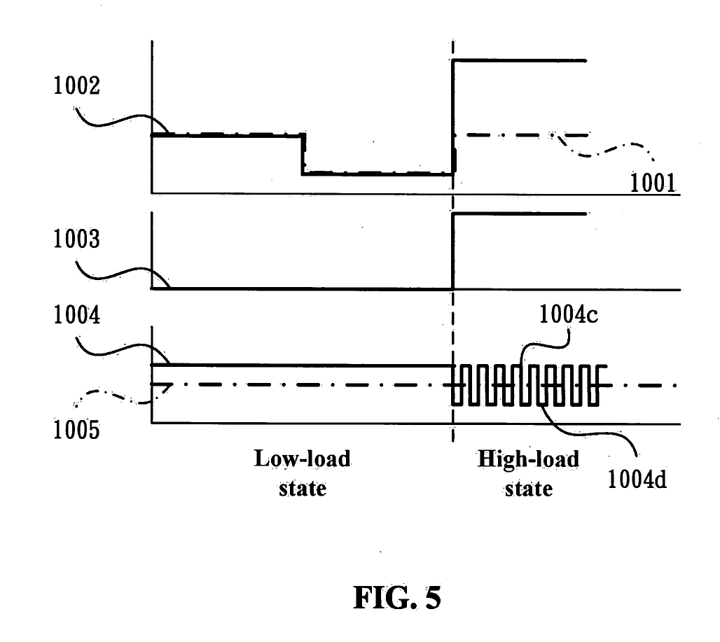

FIG. 5 is another diagram showing the signal control of the hybrid power supply apparatus with fuel cell output control according to the invention. In this embodiment, the hybrid power supply apparatus with fuel cell output control, through the control of the first power supply circuit preset output voltage (1004), forms a voltage signal pattern oscillating between a third preset voltage level (1004c) with higher potential and a fourth preset voltage level (1004d) with lower potential in the high-load state, wherein through controlling the differential between the first power supply circuit preset output voltage (1004) and the second power supply circuit preset output voltage (1005), the hybrid power supply apparatus could control the output distribution ratio between the first power supply circuit output power (1001) and the second power supply circuit output power (1003) such that the sum of first power supply circuit output power (1001) and second power supply circuit output power (1003) could reach the load power loss (1002) of the load (300). In addition, by controlling the duty cycle formed by oscillation between the third preset voltage level (1004c) and the fourth preset voltage level (1004d) of the first power supply circuit preset output voltage (1004) in high-load state, the output distribution ratio between the first power supply circuit output power (1001) and the second power supply circuit output power (1003) could be controlled such that the sum of first power supply circuit output power (1001) and second power supply circuit output power (1003) could reach the load power loss (1002) of the load (300).

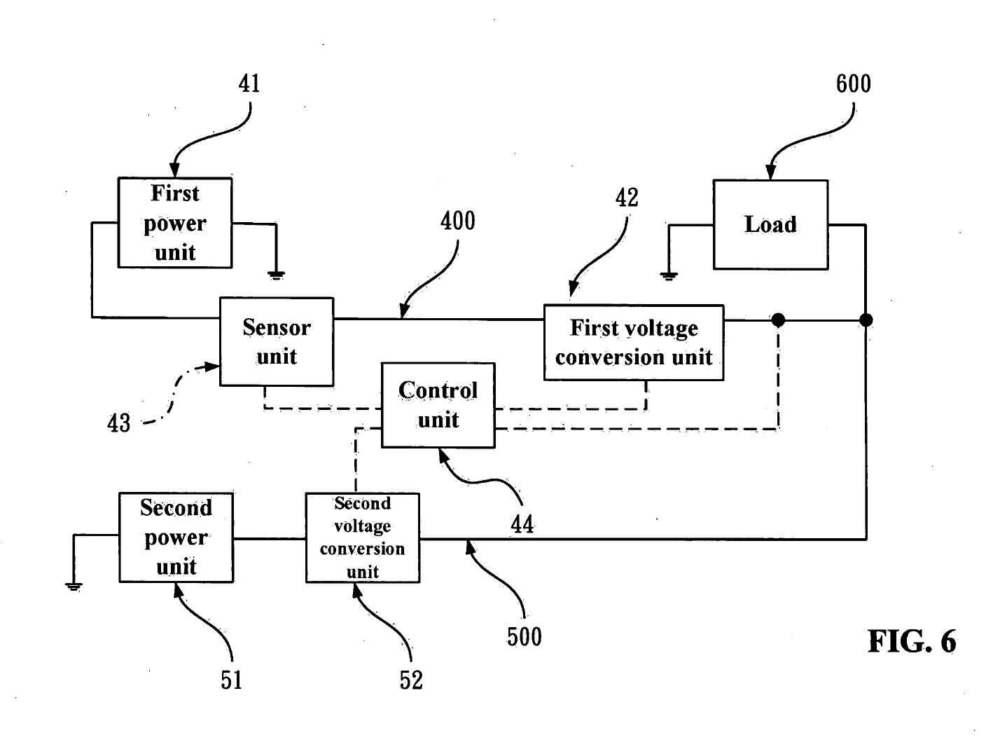

FIG. 6 is the component diagram of a hybrid power supply apparatus with fuel cell output control according to a fourth embodiment of the invention. In this embodiment, the hybrid power supply apparatus with fuel cell output control comprises a first power unit (41), a first voltage conversion unit (42), a sensor unit (43), a control unit (44), and a first power supply circuit (400), where the DC power outputted by the first power unit (41) is transmitted to the first voltage conversion unit (42) via the first power supply circuit (400) to undergo voltage conversion and output a DC power of specific voltage. The converted DC power is then transmitted to the load (600) via the first power supply circuit (400) to supply the DC power needs of the load (600).

In the hybrid power supply apparatus with fuel cell output control, the first voltage conversion unit (42) is a circuit with a mechanism to store and release energy from the inputted DC power and electrically connected in series in the first power supply circuit (400). The control signal provided by the control unit (44) controls the operation of the first voltage conversion unit (42). The control unit (44) is a logic operation and logic control circuit, e.g. a microcontroller with an input terminal and an output terminal for the input and output of electrical signal, which respectively provides the feedback signal needed for the logic operation and outputs the control signal obtained after the logic operation. The sensor unit (43) is able to detect the current, voltage or electric power of the first power supply circuit (400), and feeds a signal corresponding to the detected result to the control unit (44). The control unit (44) would output a control signal corresponding to the signal fed by the sensor unit (43) to the first voltage conversion unit (42) so as to control the operation of the first voltage conversion unit (42). When the power characteristic detected by the sensor unit (43) falls within a first preset range, the control unit (44) would output a corresponding control signal to control the conversion of inputted DC power by the first voltage conversion unit (42) into stable voltage power for output; and when the power characteristic detected by the sensor unit (43) falls within a second preset range, the control unit (44) would output another corresponding control signal to control the conversion of inputted DC power by the first voltage conversion unit (42) into power of specific voltage for output and enable the power characteristic detected by the sensor unit (43) to return to the first preset range. Generally, the second preset range defined is higher than the first preset range defined such that power outputted by the first power unit (41) could be confined, thereby controlling the power output of the first power unit (41) and protecting the first power unit (41).

The control unit (44) is electrically connected to the second voltage conversion unit (52) in the second power supply circuit (500), and able to control the first voltage conversion unit (42) in the first power supply circuit (400) and the second voltage conversion unit (52) in the second power supply circuit (500) based on the voltage signal outputted by the sensor unit (43) in the first power supply circuit (400). As such, the control unit (44) can determine the output distribution ratio between the first power supply circuit (400) and the second power supply circuit (500), thereby keeping the power outputted by the first power unit (41) at the expected current level.

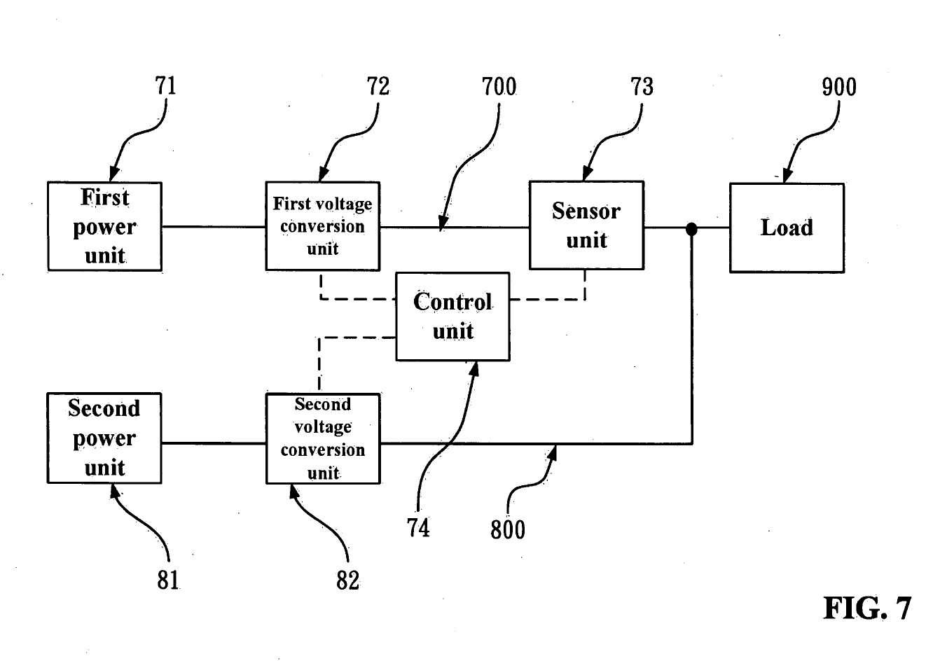

FIG. 7 is the component, diagram of a hybrid power supply apparatus with fuel cell output control according to a fifth embodiment of the invention. In this embodiment, the hybrid power supply apparatus with fuel cell output control comprises a first power supply circuit (700) and a second power supply circuit (800). The first power supply circuit (700) comprises a first power unit (71), a first voltage conversion unit (72), a control unit (74), and a sensor unit (73), where the DC power outputted by the first power unit (71) is transmitted to the first voltage conversion unit (72) via the first power supply circuit (700) to undergo voltage conversion and output a DC power of specific voltage. The converted DC power is then transmitted to the load (600) via the first power supply circuit (750) to supply the DC powder needs, of the load (600). The second power supply circuit (800) comprises a second power unit (81) and a second voltage conversion unit (82). The components in this embodiment are identical to the ones in the previously described embodiment, only the control unit (74) could control simultaneously the first voltage conversion unit (72) in the first power supply circuit (700) and the second voltage conversion unit (82) in the second power supply circuit (800) such that the control unit (74) could coordinate power output by the first power supply circuit (700) and the second power supply circuit (800) based on the power output of the first power unit (71) in the first power supply circuit (700).

In the embodiments of the invention, the sensor unit can be disposed at any position in the first power supply circuit, or at the high side or low side of the first power supply circuit. Although there is no restriction on the position of the sensor unit in the first power supply circuit, the output power of the first power supply circuit is determined by the foresaid position.

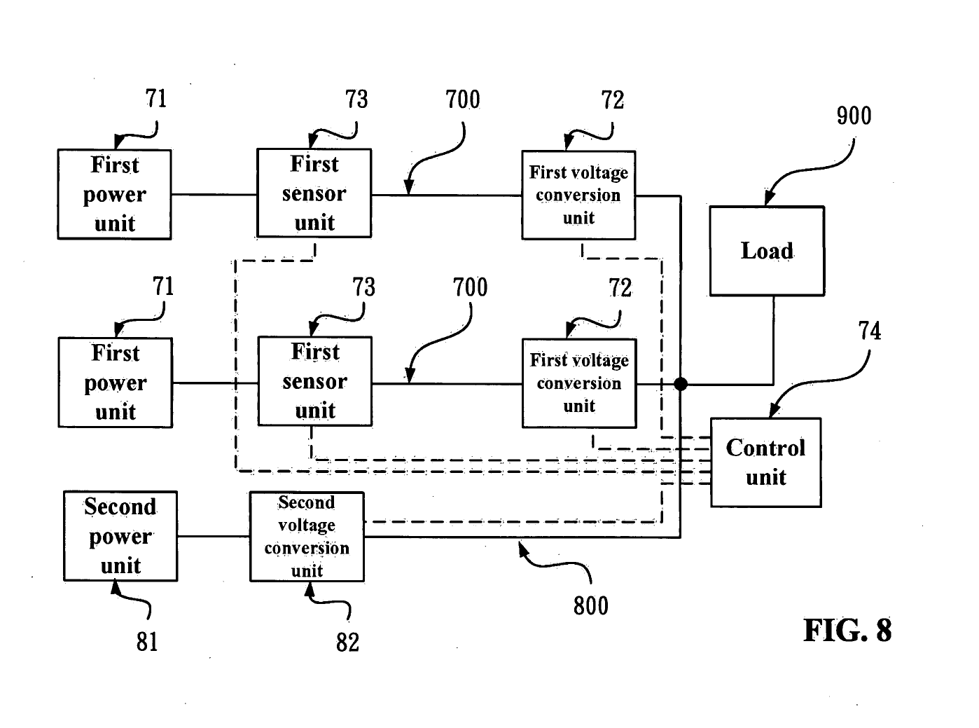

FIG. 8 is the component diagram of a hybrid power supply apparatus with fuel cell output control according to a sixth embodiment of the invention. In this embodiment, the hybrid power supply apparatus with fuel cell output control comprises a plurality of first power supply circuit (700) and at least a second power supply circuit (800). The control unit (74) could control simultaneously the first voltage conversion units (72) in the first power supply circuits (700) and the second voltage conversion unit (82) in the second power supply circuit (800) such that the control unit (74) could coordinate power output by the first power supply circuits (700) and the second power supply circuit (800) based on the power output of the first power unit (71) in the first power supply circuit (700).

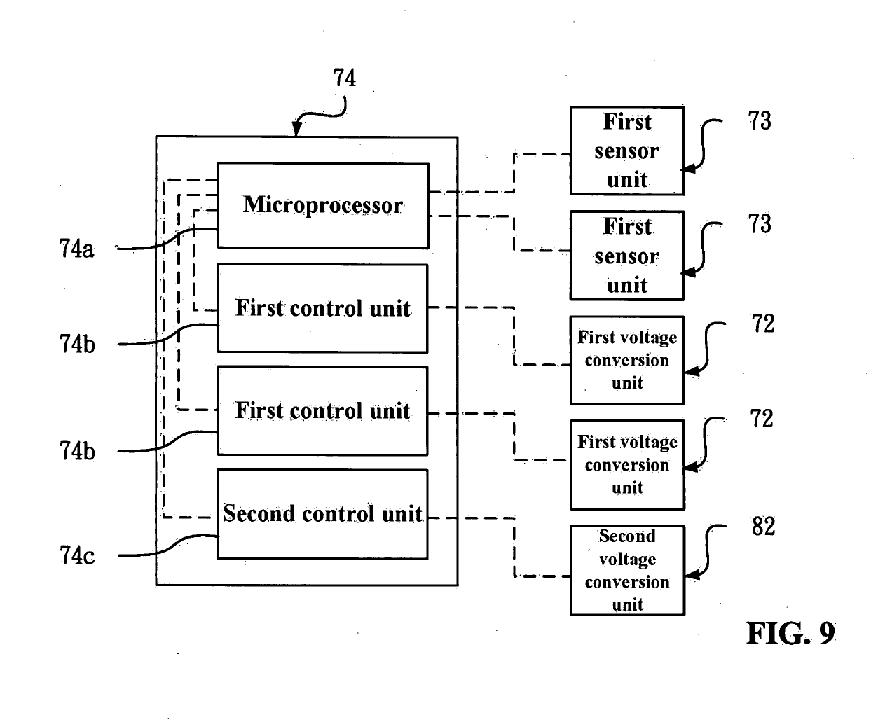

FIG. 9 is a partial component diagram of the six embodiment of the invention. The control unit (74) further contains a microcontroller (74a), a plurality of first control units (74b) corresponding respectively to the first power supply circuits (700), and a second control unit (74c) corresponding to the second power supply circuit (800). The microcontroller (74a) has logic operation and logic control means, and carries out logic operation based on the electrical signal outputted by the first sensor units (73) and outputs a corresponding electrical signal. The first control units (74b) and the second control unit (74c) respectively output voltage signal corresponding to the electrical signal outputted by the microcontroller (74a) to bring about corresponding operations of the first voltage conversion unit (72) and the second voltage conversion unit (82), thereby achieving the monitoring of the current level of the first power supply circuits (700) and regulation of the output power of respective power circuits.

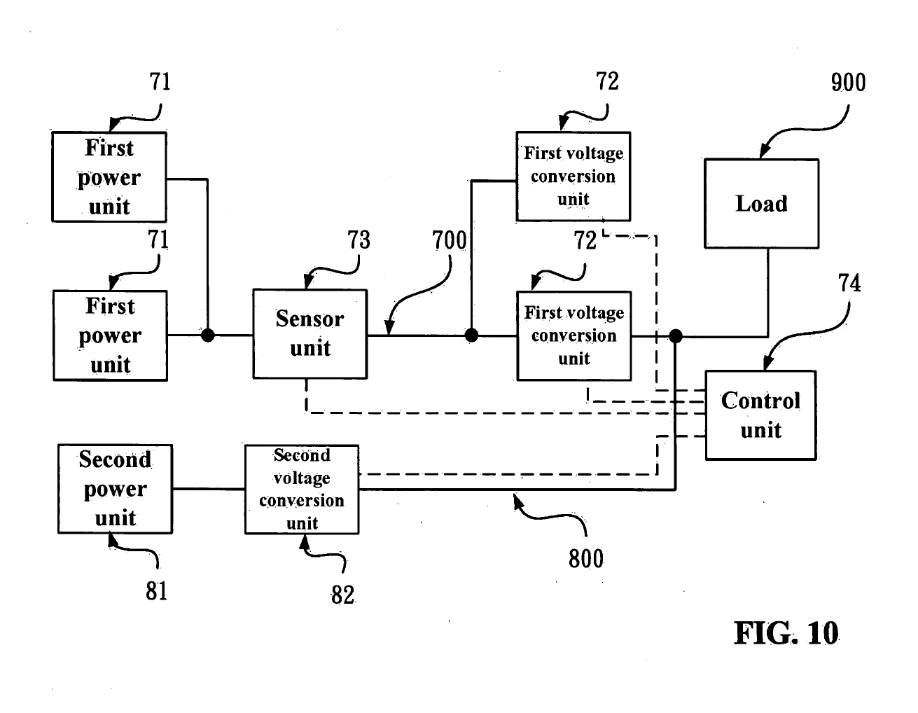

FIG. 10 is the component diagram of a hybrid power supply apparatus with fuel cell output control according to a seventh embodiment of the invention. Based on the embodiment of hybrid power supply apparatus with fuel cell output control described above, the first power supply circuit (700) in this embodiment comprises a plurality of first power units (71) and a plurality of first voltage conversion units (72), and the second power supply circuit (800) comprises a second power unit (81) and a second voltage conversion unit (82). The control unit (74) could control simultaneously the first voltage conversion units (72) and the second voltage conversion unit (82) such that the control unit (74) could coordinate power output by the first power supply circuit (700) and the second power supply circuit (800) based on the power output of the first power unit (71).

In the embodiments shown in FIG. 5, FIG. 6, FIG. 7, FIG. 8 and FIG. 10, and again referring to FIG. 4, in the high-load state, the control unit would regulate simultaneously the voltage conversion operation of the first voltage conversion unit and the second voltage conversion unit based on the signal fed from the sensor unit such that the first power supply circuit preset output voltage (1004) and the second power supply circuit preset output voltage (1005) would vacillate alternately, which enables the first power supply circuit and the second power supply circuit to output power synchronously to the load, and at the same time, enable the sum of first power supply circuit output power (1001) and the second power supply circuit output power (1003) to be equal to the load power loss (1002) of the load (300). Hence the hybrid power supply apparatus with fuel cell output control of the invention could enable the first power unit to maintain stable power output, and at the same time, satisfy the power demand of the load in low-load state and high-load state by controlling the voltage output of the first voltage conversion unit and the second voltage conversion unit and coordinating the power output of the second power supply circuit.

The examples cited above are meant to explain the invention and should not be construed as a limitation on the actual applicable scope of the invention, and as such, all modifications and alterations without departing from the spirits of the invention and appended claims shall remain within the protected scope and claims of the invention.

What is claimed is:

1. A hybrid power supply apparatus with fuel cell output control, comprising:
a first power supply circuit, further comprising:
a first power unit, the first power unit being a fuel cell power generating device;
a first voltage conversion unit, the first voltage conversion unit being a power voltage conversion device with one end being electrically connected to the first power unit and, being able to convert the power generated by the first power unit and inputted into its input terminal, into DC power of specific voltage for output;
a sensor unit, the sensor unit being a power detecting device for detecting the characteristic of power transmitted by the first power supply circuit and for outputting an electrical signal corresponding to said power characteristic;
a control unit, the control unit outputting specific voltage signal corresponding to the electrical signal outputted by the sensor unit, the input terminal of the control unit being electrically connected to the sensor unit, and its output terminal being electrically connected to the first voltage conversion unit;
a second power supply circuit, further comprising:
a second power unit, the second power unit being a power generating device;
a second voltage conversion unit, the second voltage conversion unit being a power voltage conversion device with one end being electrically connected to the second power unit and, being able to convert the power generated by the second power unit and inputted into its input terminal, into DG power of specific voltage for output;
wherein the output of the first power supply circuit and the output of the second power supply circuit are electrically connected in parallel, the control unit regulates the differential between the output voltage of the first voltage conversion unit and the output voltage of the second voltage conversion unit according to the signal fed by the sensor unit such that the first power supply circuit and the second power supply circuit outputs power synchronously to the load.

2. The hybrid power supply apparatus with fuel cell output control according to claim 1, wherein the first voltage conversion unit includes at least a DC voltage booster circuit and at least a DC voltage buck circuit.

3. The hybrid power supply apparatus with fuel cell output control according to claim 1, wherein the first control unit further comprises a pulse signal generator and a pulse-to-voltage converter circuit, the pulse signal generator being an electrical device that generates pulse signals with specific duty cycle, the pulse-to-voltage converter circuit being a device that converts pulse signal into a voltage signal and outputting a voltage signal corresponding to the pulse signal generated by the pulse signal generator.

4. The hybrid power supply apparatus with fuel cell output control according to claim 3, wherein the pulse-to-voltage converter circuit includes a voltage follower.

5. The hybrid power supply apparatus with fuel cell output control according to claim 3, wherein the first control unit further comprises a microprocessor, the microprocessor receiving the electrical signal outputted by the sensor unit and correspondingly controlling the output of the pulse-to-voltage converter circuit.

6. The hybrid power supply apparatus with fuel cell output control according to claim 5, wherein the pulse-to-voltage converter circuit outputs pulse signals of specific duty cycle.

7. The hybrid power supply apparatus with fuel cell output control according to claim 1, wherein the sensor unit is partially electrically connected in series to the electrical loop of the first power supply circuit and detects the current, voltage or electric power of the first power supply circuit, and outputs an electrical signal corresponding to the power state of the first power supply circuit to the first control unit.

8. The hybrid power supply apparatus with fuel cell output control according to claim 7, wherein the sensor unit further comprises a resistor and a voltage comparator, the resistor being electrically connected in series in the first power supply circuit, the voltage comparator being electrically connected to the resistor in parallel and outputting ah electrical signal corresponding to the voltage across the resistor to the control unit.

9. The hybrid power supply apparatus with fuel cell output control according to claim 8, wherein the voltage comparator is a circuit formed by voltage differential amplifier, the two input terminals of voltage comparator being electrically connected in parallel to the two ends of the resistor, while its output terminal being electrically connected to the control unit and outputting an electrical signal corresponding to the voltage across the resistor.

10. The hybrid power supply apparatus with fuel cell output control according to claim 1, wherein the first voltage conversion unit further comprises a voltage conversion circuit, a voltage conversion control device and a judging device, the voltage conversion control device controlling the voltage conversion circuit to select the electrical circuit for energy storage or energy release, the judging device being electrically connected to the voltage signal output terminal of the control unit at one end and feeding an electrical signal corresponding to the voltage signal outputted by the control unit to the voltage conversion control device.

11. The hybrid power supply apparatus with fuel cell output control according to claim 10, wherein the judging device further comprises a voltage differential amplifier and a reference voltage device, one input terminal of the voltage differential amplifier being electrically connected to the output terminal of the control unit, while another input terminal being electrically connected to the reference voltage device to compare the voltage at the feedback voltage junction and the voltage of the reference voltage device and output the result of comparison to the voltage conversion control device.

12. The hybrid power supply apparatus with fuel cell output control according to claim 11, wherein the voltage conversion control device outputs a duty-cycle signal based on the comparison result of the voltage differential amplifier, to control the voltage conversion circuit to select the electrical circuit for energy storage or energy release.

13. The hybrid power supply apparatus with fuel cell output control according to claim 1, wherein the control unit outputs a specific voltage signal corresponding to the electrical signal outputted by the sensor unit, the input terminal of the control unit being electrically connected to the sensor unit and its output terminal being electrically connected to the first voltage conversion unit.

14. The hybrid power supply apparatus with fuel cell output control according to claim 13, wherein the other output terminal of the control unit is electrically connected to the second voltage conversion unit.

15. The hybrid power supply apparatus with fuel cell output control according to claim 1, wherein the control unit outputs a specific voltage signal corresponding to the electrical signal outputted by the sensor unit, the input terminal of the control unit being electrically connected to the sensor unit and its output terminal being electrically connected to the second voltage conversion unit.

16. The hybrid power supply apparatus with fuel cell output control according to claim 1, further comprising a plurality of first power supply circuits, the plurality of first power supply circuits outputting power by electrical connection in parallel.

17. The hybrid power supply apparatus with fuel cell output control according to claim 1, wherein the first power supply circuit further comprises a plurality of first power units and a plurality of first voltage conversion units, the plurality of first power units outputting power by electrical connection in parallel, and the plurality of first voltage conversion units outputting voltage by electrical connection in parallel.

18. The hybrid power supply apparatus with fuel cell output control according to claim 1, wherein the state of the first power supply circuit predetermined output voltage being slightly higher than the second power supply circuit predetermined output voltage, corresponds to the output power of the first power supply circuit being higher than the output power of the second power supply circuit; and the state of the first power supply circuit predetermined output voltage being slightly lower than the second power supply circuit predetermined output voltage, corresponds to the output power of the first power supply circuit being lower than the output power of the second power supply circuit.

19. The hybrid power supply apparatus with fuel cell output control according to claim 1, wherein the control unit regulates the differential between the voltage output from the first voltage conversion unit and the voltage output from the second voltage conversion unit according to the signal fed from the sensor unit, the voltage differential forming a voltage signal of specific duty cycle to control the power output distribution ratio between the first power supply circuit and the second power supply circuit and to enable the first power supply circuit and the second power supply circuit to output power synchronously to the load.

20. The hybrid power supply apparatus with fuel cell output control according to claim 1, wherein the second voltage conversion unit includes at least a DC voltage booster circuit and at least a DC voltage buck circuit.

21. The hybrid power supply apparatus with fuel cell output control according to claim 1, wherein the sensor unit is disposed at the high side or the low side of the first power supply circuit.

22. The hybrid power supply apparatus with fuel cell output control according to claim 1, wherein the control unit comprises a voltage generator device and a voltage divider, the voltage generator device including a second voltage differential amplifier, the second voltage differential amplifier having a reference voltage and an input terminal being electrically connected to the output terminal of the sensor unit, the output terminal of the second voltage differential amplifier being electrically connected to the second resistor element of the voltage divider.

23. The hybrid power supply apparatus with fuel cell output control according to claim 22, wherein the first voltage conversion unit further comprises a voltage conversion circuit, a voltage conversion control device, and a judging device, the voltage conversion circuit being a circuit with a mechanism for storing and releasing energy from the DC power and being able to convert the power at the input terminal into power of specific voltage for output; the voltage conversion control device being an electrical circuit controlling the voltage conversion circuit to select energy storage or energy release; and the judging device being electrically connected to the voltage signal output terminal of the control unit at one end, and feeding a corresponding electrical signal to the voltage conversion control device, according to the voltage signal outputted by the control unit.

24. The hybrid power supply apparatus with fuel cell output control according to claim 23, wherein the voltage conversion control device, judging device, voltage divider, control unit and sensor unit can be electrically connected to form an integrated circuit.
